(19) United States
(12) Patent Application Publication
(10) Pub. No.: US 2014/0174409 A1
(43) Pub. Date: Jun. 26, 2014

(54) Gear Pump Protection Valve

(71) Applicant: David Lloyd Ripley, San Diego, CA (US)

(72) Inventor: David Lloyd Ripley, San Diego, CA (US)

(73) Assignee: United Techologies Corporation, Hartford, CT (US)

(21) Appl. No.: 13/725,026

(22) Filed: Dec. 21, 2012

(51) Int. Cl. F02M 39/02

(52) U.S. Cl. CPC F02M 39/02
USPC 123/506

(57) ABSTRACT

A fuel system is disclosed. The fuel system may include a fuel supply, a fuel supply conduit fluidly connecting the fuel supply to an engine, and a fuel pump in fluid communication with the fuel supply conduit. The fuel system may also include a bypass conduit including a first end fluidly connected to the fuel supply conduit proximate an inlet of the fuel pump, and a second end fluidly connected to the fuel supply conduit proximate an outlet of the fuel pump. The fuel system may also include a bypass valve in fluid communication with the bypass conduit. The bypass valve may be configured to allow fuel to flow from the first end to the second end of the bypass conduit.

### FIELD OF THE DISCLOSURE

The present disclosure relates generally to gas turbine engines and, more particularly, to fuel systems for gas turbine engines.

### BACKGROUND OF THE DISCLOSURE

Large commercial aircraft typically include on-board auxiliary power units (APUs) to provide electrical, hydraulic, or pneumatic power for systems throughout the aircraft. APUs typically comprise gas turbine engines having a compressor and a turbine, between which a combustor burns fuel. Through a gearbox or direct drive, the turbine provides mechanical input to an electrical generator, while compressed air bled from the compressor may be used to supply various environmental controls. For example, when an aircraft is on the ground, the primary propulsion engines of the aircraft are typically shut down, and in this case the APU provides the main source of power for a variety of systems, such as the environmental control systems, hydraulic pumps, electrical systems, and main engine starters. The APU may also provide power during in-flight operations, such as for electrical and pneumatic systems.

Fuel is sent to the combustion section of an APU by one or more fuel pumps. Gear type fuel pumps are commonly used, and include spur gears mounted on pump bearings. If there is greater pressure at the inlet of the fuel pump than at the outlet of the fuel pump, certain parts of the fuel pump may experience damage. For example, if there is greater inlet pressure than discharge pressure, the pump bearings may unload, thereby causing the spur gears to shift and damage the bearings. Accordingly, there exists a need to for a way to protect the fuel pump of an APU when the inlet pressure is greater than the discharge pressure.

### SUMMARY OF THE DISCLOSURE

According to one embodiment of the present disclosure, a fuel system is disclosed. The fuel system may comprise a fuel supply, a fuel supply conduit fluidly connecting the fuel supply to an engine, a fuel pump in fluid communication with the fuel supply conduit, a bypass conduit including a first end fluidly connected to the fuel supply conduit proximate an inlet of the fuel pump, and a second end fluidly connected to the fuel supply conduit proximate an outlet of the fuel pump, and a bypass valve in fluid communication with the bypass conduit, the bypass valve configured to allow fuel to flow from the first end to the second end of the bypass conduit.

In a refinement, the bypass valve may open when fuel pressure at the inlet of the fuel pump is greater than fuel pressure at the outlet of the fuel pump.

In another refinement, the fuel pump may be a mechanical fuel pump, and the fuel system may further comprise an electric fuel pump located on the fuel supply conduit upstream of the mechanical fuel pump and downstream of the fuel supply.

In a related refinement, the first end of the bypass conduit may be fluidly connected downstream of the electric fuel pump.

In a related refinement, the fuel system may further comprise a fuel metering unit for managing the fuel flow to the engine, the fuel metering unit may be located on the fuel supply conduit downstream of the mechanical fuel pump.

In a related refinement, the second end of the bypass conduit may be fluidly connected upstream of the fuel metering unit.

In another refinement, the fuel system may further comprise a relief conduit including a first end fluidly connected to the fuel supply conduit near the outlet of the fuel pump, and a second end fluidly connected to the fuel supply conduit near the inlet of the fuel pump, and a relief valve located on the relief conduit, the relief valve having an open configuration for allowing fuel to flow from the first end to the second end of the relief conduit.

In another refinement, the bypass valve may protect the fuel pump from damage caused by fuel pressure at the inlet of the fuel pump being greater than fuel pressure at the outlet of the fuel pump.

In another refinement, the bypass valve may prevent reverse pressurization of the fuel pump.

In yet another refinement, the bypass valve may remain closed when the fuel pressure at the outlet of the fuel pump is greater than or equal to the fuel pressure at the inlet of the fuel pump.

According to another embodiment of the present disclosure, an engine is disclosed. The engine may comprise a fuel system. The fuel system may include a fuel pump directing a fuel flow to the combustor section, a bypass conduit leading from a position upstream of the fuel pump to a position downstream of the fuel pump, and a bypass valve in fluid communication with the bypass conduit, the bypass valve configured to allow fuel to flow through the bypass conduit and bypass the fuel pump.

In a refinement, the bypass valve may open when a fuel pressure upstream of the fuel pump is greater than a fuel pressure downstream of the fuel pump.

In a refinement, the fuel system may further include a fuel supply conduit fluidly connecting a fuel supply, the fuel pump and the combustor section in series, and wherein the bypass conduit is fluidly connected to the fuel supply conduit.

In a related refinement, the fuel pump may be a mechanical fuel pump, the fuel system may further comprise an electric fuel pump located on the fuel supply conduit downstream of the fuel supply and upstream of the mechanical fuel pump.

In a related refinement, the electric fuel pump may be located upstream of the bypass conduit.

In a related refinement, the fuel system may further include a relief conduit fluidly connected to the fuel supply conduit, the relief conduit including an inlet downstream of the mechanical fuel pump and an outlet upstream of the mechanical fuel pump, and a relief valve inserted in the relief conduit, the relief valve that when open allows fuel to flow from the inlet to the outlet of the relief conduit.

In a related refinement, the fuel system may further include a fuel metering unit for managing the fuel flow to the combustor section, the fuel metering unit located on the fuel supply conduit downstream of the mechanical fuel pump.

In another refinement, the bypass valve may remain closed when a fuel pressure downstream of the fuel pump is greater than or equal to a fuel pressure upstream of the fuel pump.

According to yet another embodiment of the present disclosure, a method for preventing damage to a fuel pump of an engine is disclosed. The method may comprise allowing fuel flow through the bypass conduit when a fuel pressure at an inlet of the fuel pump is greater than a fuel pressure at an outlet of the fuel pump, and substantially preventing fuel flow through the bypass conduit when the fuel pressure at the inlet of the fuel pump is less than the fuel pressure at the outlet of the fuel pump.

In a refinement, the method may further comprise providing the engine with an electric fuel pump upstream of and in series with the fuel pump.

These and other aspects and features of the disclosure will become more readily apparent upon reading the following detailed description when taken in conjunction with the accompanying drawings. Although various features are disclosed in relation to specific exemplary embodiments of the invention, it is understood that the various features may be combined with each other, or used alone, with any of the various exemplary embodiments of the invention without departing from the scope of the invention.

### BRIEF DESCRIPTION OF THE DRAWINGS

FIG. 1 is a schematic diagram of a fuel system according to an embodiment;

FIG. 2 is a schematic diagram of a fuel system, according to another embodiment;

FIG. 3 is a flowchart outlining a method for preventing damage to a mechanical gear driven fuel pump, according to yet another embodiment;

FIG. 4 is a cross-sectional view of part of an engine according to an embodiment; and

FIG. 5 is a top schematic view of an auxiliary power unit within a tail section of an aircraft according to an embodiment.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents falling within the spirit and scope of the present disclosure.

### DETAILED DESCRIPTION

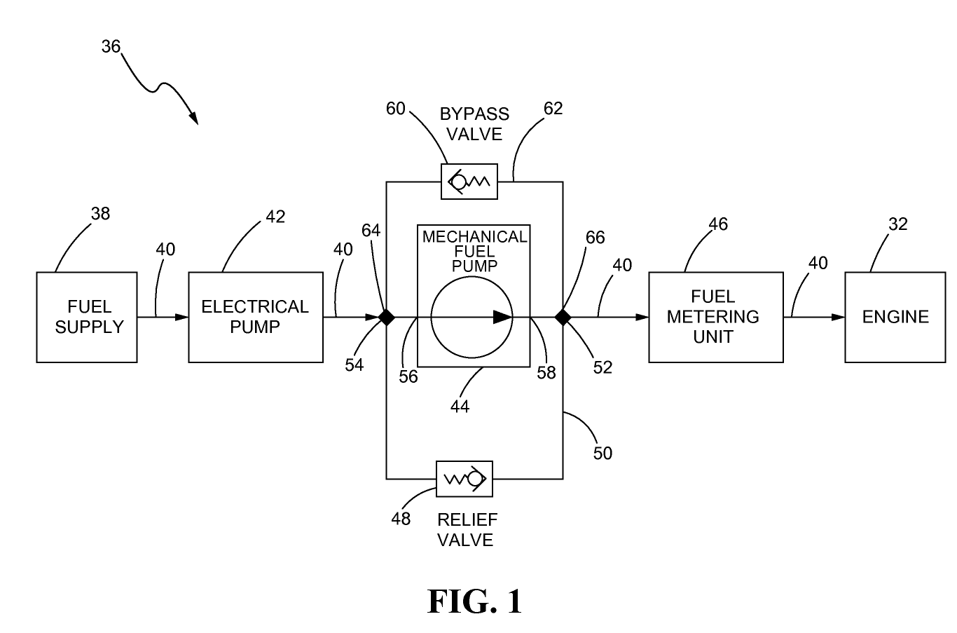

Referring now to the drawings, and with specific reference to FIG. 1, in accordance with the teachings of the disclosure, an exemplary fuel system 36 is shown. Fuel system 36 may include a fuel supply 38, fuel supply conduit 40, electric fuel pump 42, mechanical fuel pump 44, and fuel metering unit 46. Fuel system 36 provides fuel from the fuel supply 38 to an engine 32 for combustion. Fuel supply conduit 40 fluidly connects fuel supply 38 to a combustor section of the engine 32. For example, fuel supply conduit 40 may connect fuel supply 38, electric fuel pump 42, mechanical fuel pump 44, fuel metering unit 46, and engine 32 in flow series. More specifically, along fuel supply conduit 40, fuel metering unit 46 is located upstream of engine 32, mechanical fuel pump 44 is located upstream of fuel metering unit 46, electric fuel pump 42 is located upstream of mechanical fuel pump 44, and fuel supply 38 is located upstream of electric fuel pump 42. It is to be understood that fuel system 36 is presented in a simplified form and can additionally include controllers, boost pumps, filters, heat exchangers, and/or other components.

Mechanical fuel pump 44 may comprise a gear-driven fuel pump that pumps fuel from fuel supply 38 to fuel metering unit 46, which then manages and provides the desired fuel flow to engine 32. Electric fuel pump 42 may comprise an electric motor-driven fuel pump added in series with and located upstream of the mechanical fuel pump 44 to supplement fuel flow when mechanical fuel pump 44 is operating at low rotational speeds, such as during engine starting. A relief valve 48 located on a relief conduit 50 having an inlet or first end 52 and an outlet or second end 54 may be added to fuel system 36.

More specifically, relief conduit 50 connects fuel supply conduit 40 downstream of mechanical fuel pump 44 to fuel supply conduit 40 upstream of mechanical fuel pump 44. The first end 52 of relief conduit 50 may be fluidly connected to fuel supply conduit 40 at a location downstream of mechanical fuel pump 44 and upstream of fuel metering unit 46, and the second end 54 of relief conduit 50 may be fluidly connected to fuel supply conduit 40 at a location upstream of mechanical fuel pump 44 and downstream of electric fuel pump 42. Relief valve 48 remains closed when a pressure differential across mechanical fuel pump 44 is relatively low, and opens if the pressure differential across mechanical fuel pump 44 reaches a predetermined set point. When the relief valve 48 is open, fuel flows from the first end 52 of relief conduit 50 to the second end 54 of relief conduit 50. In so doing, fuel may be recirculated from an outlet 58 of mechanical fuel pump 44 to an inlet 56 of mechanical fuel pump 44 and back through mechanical fuel pump 44 in order to prevent over-pressurization of the fuel system 36.

In addition, a bypass valve 60 located on a bypass conduit 62 having an inlet or first end 64 and an outlet or second end 66 may be added to fuel system 36. Bypass conduit 62 fluidly connects fuel supply conduit 40 upstream of mechanical fuel pump 44 to fuel supply conduit 40 downstream of mechanical fuel pump 44. More specifically, the first end 64 of bypass conduit 62 may be fluidly connected to fuel supply conduit 40 at a location upstream of mechanical fuel pump 44 and downstream of electric fuel pump 42, such as a location near the inlet 56 of mechanical fuel pump 44. The second end 66 of bypass conduit 62 may be fluidly connected to fuel supply conduit 40 at a location downstream of mechanical fuel pump 44 and upstream of fuel metering unit 46, such as a location near the outlet 58 of mechanical fuel pump 44.

Bypass valve 60 may be a passive pressure valve, such as a ball and spring, check valve, etc., that remains closed when the pressure at the outlet 58 of mechanical fuel pump 44 is greater than or equal to the pressure at the inlet 56 of mechanical fuel pump 44. When the pressure at the inlet 56 of mechanical fuel pump 44 is greater than the pressure at the outlet 58 of mechanical fuel pump 44, bypass valve 60 opens to allow fuel to flow from the first end 64 of bypass conduit 62 through the bypass conduit 62 and through bypass valve 60 to the second end 66 of bypass conduit. Thus, when the pressure differential across bypass valve 60 causes bypass valve 60 to open, fuel will bypass mechanical fuel pump 44, thereby preventing reverse pressurization of mechanical fuel pump 14 and protecting mechanical fuel pump 44 from damage caused by greater pressure at the inlet 56 than at the outlet 58 of mechanical fuel pump 44.

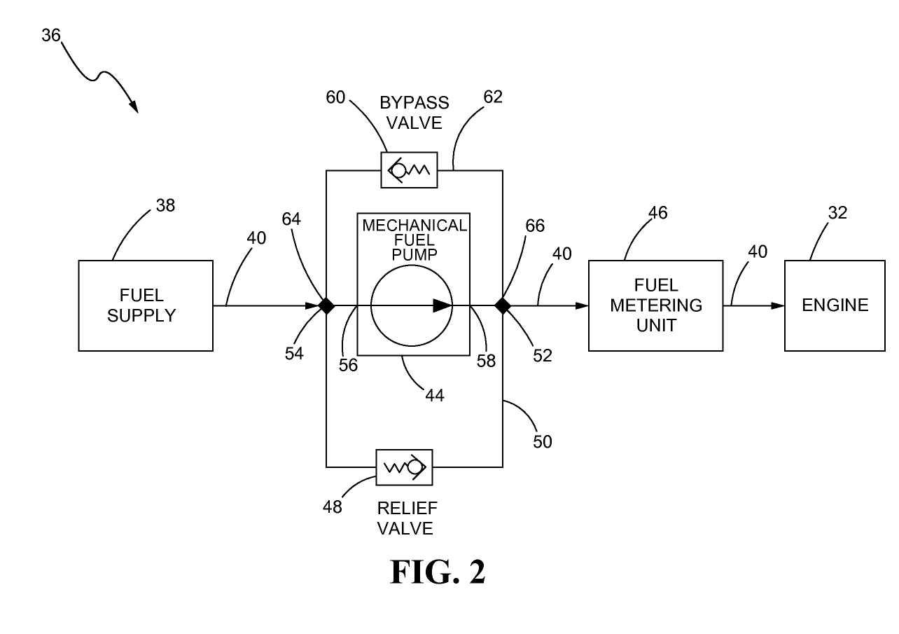

It is to be understood that although described and shown in FIG. 1 as having an electric fuel pump 42, fuel system 36 may not have an electric fuel pump 42, as shown in FIG. 2, without departing from the teachings of the disclosure.

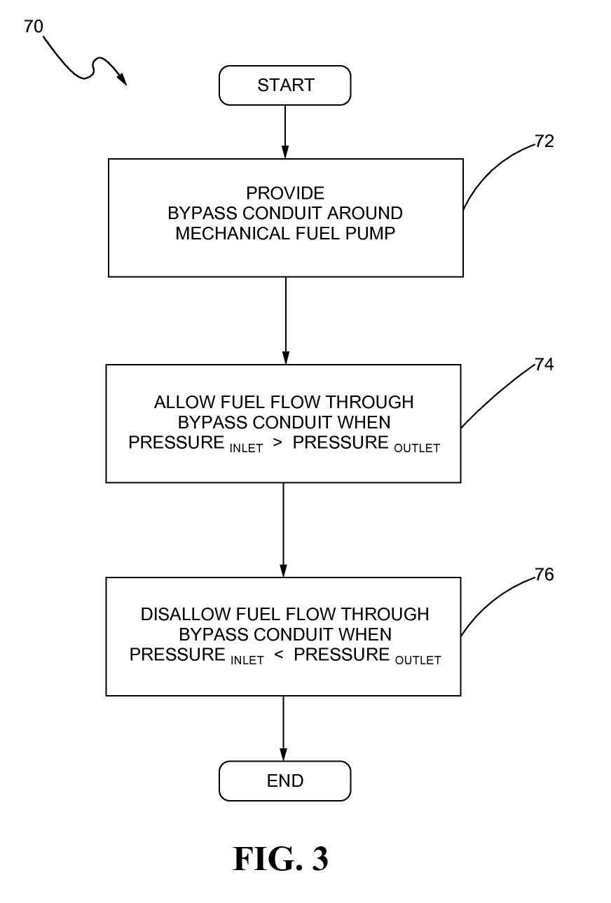

Turning now to FIG. 3, with continued reference to FIGS. 1-2, a process flow outlining a method 70 for preventing damage to a mechanical gear driven fuel pump of an engine, according to another embodiment of the present disclosure, is shown. At block 72, bypass conduit 62 may be provided around mechanical fuel pump 44. At block 74, fuel flow may be allowed through bypass conduit 62 when pressure at the inlet 56 of mechanical fuel pump 44 is greater than pressure at the outlet 58 of mechanical fuel pump 44. At block 76, fuel flow may be disallowed through bypass conduit 62 when pressure at the inlet 56 of mechanical fuel pump 44 is less than pressure at the outlet 58 of mechanical fuel pump 44.

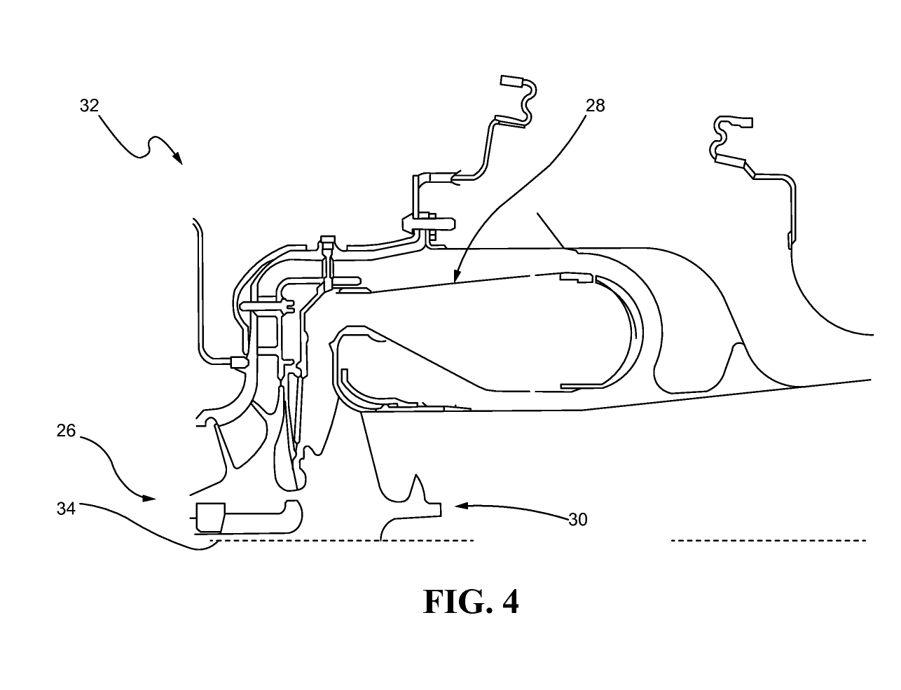

Referring now to FIG. 4, a cross-sectional view of part of the engine 32 is shown. Engine 32 may generally include a compressor section 26 where air is pressurized, a combustor section 28 downstream of the compressor section which mixes and ignites the compressed air with fuel and thereby generates hot combustion gases, and a turbine section 30 downstream of the combustor 26 for extracting power from the hot combustion gases. Compressor section 26, combustor section 28, and turbine section 30 comprise may operate to provide mechanical input via shaft 34 to various components, such as an electrical generator. The fuel system 36 of FIGS. 1-3 may be used to deliver fuel to the combustor section 28 of the engine 32.

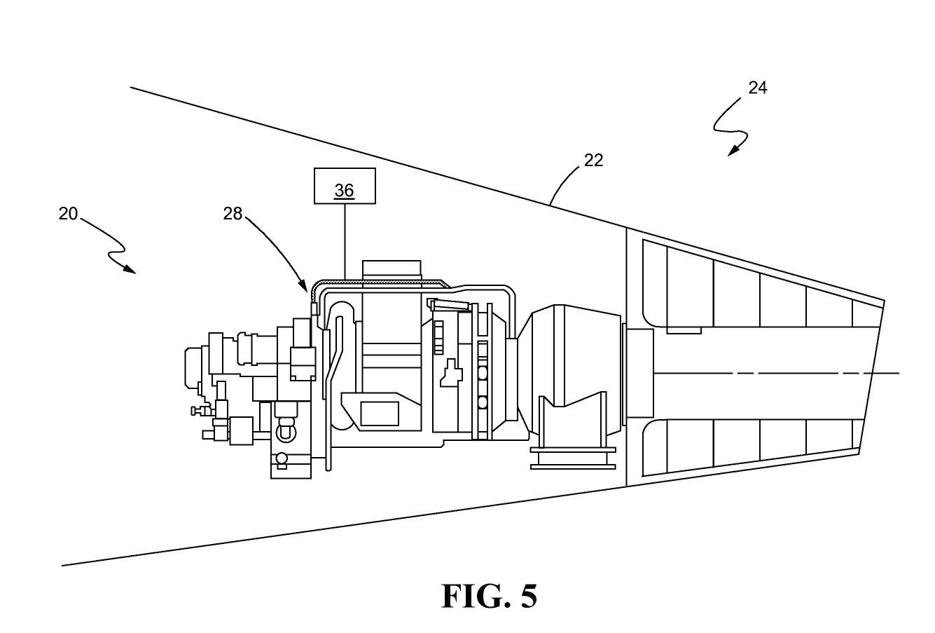

Referring now to FIG. 5, a top schematic view of an auxiliary power unit (APU) 20 within an exterior structure 22 of a tail section 24 of an aircraft is shown. The fuel system 36 of FIGS. 1-3 may also be used to deliver fuel to the combustor section 28 of the APU 20. It will be understood that although shown and described as being used with the APU 20, fuel system 36 may be used with any different type of engine without departing from the scope of this disclosure.

### INDUSTRIAL APPLICABILITY

From the foregoing, it can be seen that the teachings of this disclosure can find industrial application, technical effects and benefits in any number of different situations, including but not limited to, preventing damage to fuel systems of gas turbine engines and auxiliary power units. Such engines may be used, for example, on aircraft for generating thrust, or in land, marine, or aircraft applications for generating power.

The disclosure described provides a bypass valve and bypass conduit around a mechanical fuel pump for a fuel system. By incorporating a bypass valve and bypass conduit into the fuel system around the mechanical fuel pump, the bypass valve and conduit prevent the pump inlet pressure from exceeding the pump outlet pressure, thereby protecting the mechanical fuel pump from damage that may be caused when inlet pressure is greater than outlet pressure. More specifically, when there is greater inlet pressure than outlet pressure, the bypass valve opens and allows fuel to flow through the bypass conduit instead of flowing through the mechanical fuel pump. This allows fuel to bypass the mechanical gear-driven fuel pump instead of entering the pump, thereby preventing reverse pressurization of the fuel pump and protecting the pump from damage that may be caused by the bearings unloading and spur gears shifting when there is higher inlet pressure than outlet pressure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. A fuel system, comprising:
a fuel supply;
a fuel supply conduit fluidly connecting the fuel supply to an engine;
a fuel pump in fluid communication with the fuel supply conduit;
a bypass conduit including a first end fluidly connected to the fuel supply conduit proximate an inlet of the fuel pump, and a second end fluidly connected to the fuel supply conduit proximate an outlet of the fuel pump; and
a bypass valve in fluid communication with the bypass conduit, the bypass valve configured to allow fuel to flow from the first end to the second end of the bypass conduit.

2. The fuel system of claim 1, wherein the bypass valve opens when fuel pressure at the inlet of the fuel pump is greater than fuel pressure at the outlet of the fuel pump.

3. The fuel system of claim 1, wherein the fuel pump is a mechanical fuel pump, and further comprising an electric fuel pump located on the fuel supply conduit upstream of the mechanical fuel pump and downstream of the fuel supply.

4. The fuel system of claim 3, wherein the first end of the bypass conduit is fluidly connected downstream of the electric fuel pump.

5. The fuel system of claim 4, further comprising a fuel metering unit for managing the fuel flow to engine, the fuel metering unit located on the fuel supply conduit downstream of the mechanical fuel pump.

6. The fuel system of claim 5, wherein the second end of the bypass conduit is fluidly connected upstream of the fuel metering unit.

7. The fuel system of claim 1, further comprising:
a relief conduit including a first end fluidly connected to the fuel supply conduit near the outlet of the fuel pump, and a second end fluidly connected to the fuel supply conduit near the inlet of the fuel pump, and
a relief valve located on the relief conduit, the relief valve having an open configuration for allowing fuel to flow from the first end to the second end of the relief conduit.

8. The fuel system of claim 1, wherein the bypass valve protects the fuel pump from damage caused by fuel pressure at the inlet of the fuel pump being greater than fuel pressure at the outlet of the fuel pump.

9. The fuel system of claim 1, wherein the bypass valve prevents reverse pressurization of the fuel pump.

10. The fuel system of claim 1, wherein the bypass valve remains closed when the fuel pressure at the outlet of the fuel pump is greater than or equal to the fuel pressure at the inlet of the fuel pump.

11. An engine, comprising:
a fuel system including:
a fuel pump directing a fuel flow to a combustor section of the engine;
a bypass conduit leading from a position upstream of the fuel pump to a position downstream of the fuel pump; and
a bypass valve in fluid communication with the bypass conduit, the bypass valve configured to allow fuel to flow through the bypass conduit and bypass the fuel pump.

12. The engine of claim 11, wherein the bypass valve opens when a fuel pressure upstream of the fuel pump is greater than a fuel pressure downstream of the fuel pump.

13. The engine of claim 11, wherein the fuel system further includes a fuel supply conduit fluidly connecting a fuel supply, the fuel pump and the combustor section in series, and wherein the bypass conduit is fluidly connected to the fuel supply conduit.

14. The engine of claim 13, wherein the fuel pump is a mechanical fuel pump, and wherein the fuel system further comprises an electric fuel pump located on the fuel supply conduit downstream of the fuel supply and upstream of the mechanical fuel pump.

15. The engine of claim 14, wherein the electric fuel pump is located upstream of the bypass conduit.

16. The engine of claim 15, wherein the fuel system further includes:
a relief conduit fluidly connected to the fuel supply conduit, the relief conduit including an inlet downstream of the mechanical fuel pump and an outlet upstream of the mechanical fuel pump, and
a relief valve inserted in the relief conduit, the relief valve that when open allows fuel to flow from the inlet to the outlet of the relief conduit.

17. The engine of claim 16, wherein the fuel system further includes a fuel metering unit for managing the fuel flow to the combustor section, the fuel metering unit located on the fuel supply conduit downstream of the mechanical fuel pump.

18. The engine of claim 11, wherein the bypass valve remains closed when a fuel pressure downstream of the fuel pump is greater than or equal to a fuel pressure upstream of the fuel pump.

19. A method for preventing damage to a fuel pump of an engine, comprising:
allowing fuel flow through the bypass conduit when a fuel pressure at an inlet of the fuel pump is greater than a fuel pressure at an outlet of the fuel pump; and
substantially preventing fuel flow through the bypass conduit when the fuel pressure at the inlet of the fuel pump is less than the fuel pressure at the outlet of the fuel pump.

20. The method of claim 19, further comprising providing engine with an electric fuel pump upstream of and in series with the fuel pump.
